(19) United States
(12) Patent Application Publication
(10) Pub. No.: US 2026/0307449 A1
(43) Pub. Date: Oct. 8, 2026

(54) DAMPING VALVE DEVICE FOR A SHOCK ABSORBER OF A MOTOR VEHICLE

(71) Applicants: thyssenkrupp Bilstein GmbH, Ennepetal (DE); thyssenkrupp AG, Essen (DE)

(72) Inventors: Christoph SCHMIDT, Bonn (DE); Sven WIELENS, Gelsenkirchen (DE)

(73) Assignees: thyssenkrupp Bilstein GmbH, Ennepetal (DE); thyssenkrupp AG, Essen (DE)

(21) Appl. No.: 19/577,132

(22) Filed: Mar. 24, 2026

(30) Foreign Application Priority Data
Apr. 4, 2025 (DE) 10 2025 113 195.3

(51) Int. Cl. B60G 17/08

(52) U.S. Cl. CPC B60G 17/08; B60G 2202/24; B60G 2204/124; B60G 2206/41

(57) ABSTRACT

A vibration damper of a motor vehicle comprises an outer tube and an inner tube which is arranged so as to be coaxial with the latter, and a working piston which is arranged so as to be axially movable within the inner tube and divides the interior of the inner tube into a first, piston rod-proximal working chamber and a second, piston rod-distal working chamber, a damping valve device which is arranged, for example, in the working piston, wherein the damping valve device has: a coil, an axially movable armature which is at least partially arranged within the coil, a main valve having a main piston which separates a compression main control chamber and a rebound main control chamber from one another, wherein a preload element is provided which lies against the main piston in such a way that it applies a force to the main piston in the opening direction of the main valve.

### CROSS REFERENCE TO RELATED APPLICATION

This application is a U.S. Non-Provisional that claims priority to German Patent Application No. DE 10 2025 113 195.3, filed Apr. 4, 2025, the entire content of which is incorporated herein by reference.

### FIELD

The present disclosure relates to a damping valve device for a shock absorber for motor vehicles, wherein the damping valve device has a main valve and a pilot valve.

### BACKGROUND

DE 10 2020 215 480 A1 has disclosed a vibration damper having a damping valve device, wherein the damping valve device has a pilot valve which is adjustable via a solenoid. Unstable behaviour of the damping valve may arise, in particular in the dynamic operation of the vibration damper, when the main valve is opened and closed. In particular, the spring behaviour when the main valve is opened is often unstable, wherein acoustic problems can additionally arise. Furthermore, the installation of the damping valve device is complex and costly.

Thus a need exists to provide a damping valve device for a vibration damper, which has stable opening and closing behaviour both in the compression stage and in the rebound stage, is particularly space-saving and at the same time is simple and inexpensive to produce.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a vibration damper in a longitudinal sectional view according to one exemplary embodiment.

FIG. 2 shows a schematic illustration of a damping valve device of a vibration damper in the compression stage in a longitudinal sectional view according to one exemplary embodiment.

FIG. 3 shows a schematic illustration of a damping valve device of a vibration damper in the rebound stage in a longitudinal sectional view according to one exemplary embodiment.

FIG. 4 shows a schematic illustration of a damping valve device of a vibration damper in a longitudinal sectional view according to a further exemplary embodiment.

FIG. 5 shows a schematic illustration of a damping valve device of a vibration damper in a longitudinal sectional view according to a further exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

According to a first aspect, a vibration damper of a motor vehicle comprises an outer tube and an inner tube which is arranged so as to be coaxial with the former, and a working piston which is arranged so as to be axially movable within the inner tube and divides the interior of the inner tube into a piston rod-proximal working chamber and a piston rod-distal working chamber. The vibration damper also comprises a damping valve device which is arranged, for example, in the working piston, wherein the damping valve device has a coil and an axially movable armature which is arranged at least partially within the coil. The damping valve device also comprises a main valve having a main piston which fluidically separates a compression main control chamber, a rebound main control chamber and optionally a pilot control chamber from one another. The damping valve device also comprises a preload element which lies against the main piston in such a way that it applies a force to the main piston in the opening direction of the main valve. The preload element preferably lies against that surface of the main piston which points in the direction of the piston rod-distal working chamber, in particular in the direction of the comfort valve.

A preload of the main piston in the opening direction ensures an improved spring behaviour of the damping valve device. In particular, in a pilot-controlled or in particular feedback-controlled damping valve device, no further opening of the main valve via a movement of the piston is necessary in a main valve pre-opened by means of the preload element, up to a certain volume flow.

The damping valve device is, for example, a pressure control valve which can preferably be pilot-controlled. The main valve having the main piston is preferably designed for closing and opening the damping valve device, in particular the pressure control valve. The main piston is preferably axially movable indirectly via the pilot control valve located between the armature and the main piston, or directly by means of the armature and/or the hydraulic pressure prevailing in the pilot control chamber.

A damping valve device designed as a pilot-controlled pressure control valve preferably comprises, in addition to the main valve, a pilot valve having a pilot working chamber and a sliding tappet which is arranged in the pilot working chamber and is axially movable by means of the armature, and a connecting duct which is arranged between the pilot control chamber and the pilot working chamber and fluidically connects them to one another. The damping valve device optionally has a pilot valve which is designed and arranged in such a manner that it is able to be flowed through by hydraulic fluid in the rebound stage and in the compression stage and has a pilot working chamber and a sliding tappet that is arranged in the pilot working chamber and is axially movable by means of the armature. Furthermore, the damping valve device optionally has a connecting duct which is arranged between the pilot control chamber and the pilot working chamber and fluidically connects them to one another. The compression main control chamber is preferably fluidically connected to the pilot control chamber via a first flow passage, and the rebound main control chamber thereto via a second flow passage. In particular, the preload element is arranged in a central recess in the main piston, wherein the central recess is arranged coaxially to the connecting duct and lies directly against this or at least partially forms this.

The damping valve device is arranged in a vibration damper for a motor vehicle, for example. The vibration damper is, for example, a monotube vibration damper or a multi-tube vibration damper, by way of example a twin-tube vibration damper. The vibration damper comprises, for example, an outer tube which forms an external surface, in particular a housing, of the vibration damper. An inner tube, which is also referred to as damper tube, is arranged within the outer tube so as to be coaxial with the latter. An equalizing chamber, which is preferably at least partially filled with a hydraulic fluid, is formed between the outer tube and the inner tube. For example, the equalizing chamber is partially filled with a gas.

A working piston which is connected to a piston rod is preferably arranged within the inner tube in such a manner that said working piston is movable within the inner tube, wherein the inner tube is preferably designed as a guide of the working piston. A damping valve device is arranged on the working piston, for example. The working piston divides the interior of the inner tube, in particular, into a first, piston rod-proximal working chamber and a second, piston rod-distal working chamber.

The vibration damper preferably has a closure package which fluidically seals the interior of the outer tube on the piston rod-proximal side. At the end away from the piston rod, opposite the closure package, the interior of the outer tube is preferably fluidically sealed by means of a bottom piece. A bottom valve, which is attached to the piston rod-distal end of the inner tube, is attached, in particular, to the bottom piece.

The damping valve device comprises a preferably cylindrical damping valve housing which has a substantially tubular tube part and a housing upper part which is attached to the tube part or is formed so as to be integral to the latter. By way of example, the tube part has a connecting region which has one or a plurality of connection contacts for an electrical current supply of the damping valve device. The connection contacts for an electrical current supply are preferably connected to a drive unit.

The damping valve device preferably has a drive which is designed as a solenoid, in particular a coil having a plurality of windings made of a current-conducting wire. The coil is preferably arranged within a housing of the damping valve device and comprises, for example, a coil former, on which the windings of the coil are wound. The coil preferably at least partially or completely encloses an armature chamber which extends centrally in the axial direction. An armature is preferably mounted so as to be axially movable within the armature chamber. The armature is preferably attached so as to be able to slide in the axial direction within the armature chamber and comprises, for example, a central armature rod which, by way of example, is of tubular design and extends centrally in the axial direction through the armature chamber. The armature chamber is preferably delimited by an at least partially hollow-cylindrical pole tube which preferably serves as a guide for the armature.

The damping valve device preferably comprises a main valve and a pilot valve. The pilot valve is preferably arranged in the flow direction downstream of the main valve, both in the compression stage as well as in the rebound stage of the vibration damper. In particular, the damping valve device is able to be flowed through by hydraulic fluid in both directions. The damping valve device arranged in the working piston preferably has exactly one main valve and/or exactly one pilot valve. A seal, in particular a sealing ring, which seals the working piston in a fluid-tight manner in relation to the damper tube, is attached to the working piston, for example. The working piston preferably comprises a first fluid passage to the piston rod-proximal working chamber. The damping valve device is preferably fluidically connected to the piston rod-proximal working chamber via the first fluid passage. By way of example, in the case of a movement of the piston rod in the rebound direction, the first fluid passage is designed as a fluid inlet to allow hydraulic fluid to enter the damping valve device, and in the case of a movement of the piston rod in the compression direction, is designed as a fluid outlet to allow hydraulic fluid to exit the damping valve device. The working piston preferably has a second fluid passage to the piston rod-distal working chamber, via which the damping valve device is preferably fluidically connected to the second, piston rod-distal working chamber. In the case of a movement of the piston rod in the compression direction, the second fluid passage is preferably designed as a fluid inlet to allow hydraulic fluid to enter an optional comfort valve and/or the main valve, and in the case of a movement of the piston rod in the rebound direction, is designed as a fluid outlet to allow hydraulic fluid to exit the optional comfort valve and/or the main valve.

The main valve preferably comprises a main piston which is arranged so as to be axially movable within a main working chamber. The main valve optionally comprises a housing part which at least partially delimits the main working chamber and forms an axial guide for the main piston. The main piston is preferably arranged in such a manner that it fluidically separates a compression main control chamber, a rebound main control chamber and a pilot control chamber from one another. The main control chamber is to be understood to be the hydraulic space which is preferably directly adjacent to the main piston and preferably loads the latter with a hydraulic force in the opening direction of the main valve. A main valve which is able to be passed through by a flow in the rebound stage and in the compression stage preferably has a compression main control chamber which is designed and arranged in such a manner that it loads the main piston with a hydraulic force acting in the opening direction in the compression stage, and has a rebound main control chamber which is designed and arranged in such a manner that it loads the main piston with a hydraulic force acting in the opening direction in the rebound stage. The main valve preferably has a main valve seat, wherein, in an open position of the main valve, a main flow duct is formed between the main piston and the main valve seat. The rebound main control chamber and the compression main control chamber are preferably fluidically connected to one another via the main flow duct. The hydraulic pressure of the piston rod-distal working chamber preferably prevails in the compression main control chamber, wherein the hydraulic pressure of the piston rod-proximal working chamber preferably prevails in the rebound main control chamber.

The main valve seat is preferably formed on a guide element which is attached in a positionally fixed manner within the damping device, wherein the main piston is movable relative to said guide element. The pilot control chamber is to be understood to mean the hydraulic space which is preferably directly adjacent to the main piston and preferably loads the latter with a hydraulic force acting in the closing direction of the main valve. The pilot control chamber is preferably arranged on the main piston so as to lie opposite the rebound main control chamber and the compression main control chamber. For example, the main piston is designed in such a manner that the end surface of the main piston that faces the compression main control chamber or the rebound main control chamber and is loaded with the hydraulic pressure of the compression main control chamber or the rebound main control chamber is larger than the end surface of the main piston that faces the pilot control chamber and is loaded with the hydraulic pressure of the pilot control chamber.

During operation of the damping valve device and in the case of a movement of the piston rod in the compression direction, the hydraulic fluid preferably flows out of the piston rod-distal working chamber through the second fluid passage into the optional comfort valve, into the compression main control chamber, wherein the pressure in the compression main control chamber loads the main piston with an opening force and moves it axially upwards. Here, the main piston is lifted from the main valve seat and the hydraulic fluid flows through the main flow duct to the rebound main control chamber, in particular the second fluid passage, and subsequently into the piston rod-proximal working chamber. At the same time, in particular hydraulically parallel therewith, a partial flow of the hydraulic fluid flows through the pressure flow passage in the main piston to the pilot control chamber and loads the main position with a closing force in the direction of the main valve seat. The closing force determines the opening width of the main valve, in particular the cross section of the main flow duct, which determines the damping force of the damping valve device. The pressure in the pilot control chamber is preferably set by the pilot valve, wherein the hydraulic fluid flows from the pilot control chamber through the connecting duct into the pilot working chamber which is released by the sliding tappet. The opening width, in particular the outflow cross section, of the connecting duct is preferably dependent on the axial position of the sliding tappet, which is set by means of the solenoid. In the closed position of the pilot valve, the sliding tappet preferably closes the connecting duct completely in such a way that the hydraulic pressure in the pilot control chamber increases to a maximum value and the main valve is closed in that the main piston is pressed onto the main valve seat. In an open position of the pilot valve, the connecting duct is at least partially released by the sliding tappet. The main piston has, for example, a first piston region which is adjoined in the axial direction by a second piston region with a smaller diameter than the first piston region. The first flow passage preferably extends exclusively through the first piston region of the main piston, in particular centrally and in the axial direction through the latter into the pilot control chamber. A flow throttle in each flow passage permits separate setting of the flow throttling action in the rebound stage and the compression stage.

According to a first embodiment, the preload element is attached by means of a fastening element to a stationary element of the damping valve device. In particular, the preload element lies with one end against the fastening element or is firmly attached to the latter. With the opposite, other end, the preload element preferably lies against the main piston. Preferably, the preload element is arranged in a central recess, in particular bore, of the main piston. The central recess is preferably arranged coaxially to the connecting duct, preferably merges into the connecting duct or forms the latter at least partially. The recess preferably extends centrally along the centre axis of the vibration damper.

According to a further embodiment, the fastening element is connected, in particular pressed, to the stationary element in a non-positively and/or positively locking manner. The stationary element is preferably attached in a stationary manner within the working piston and, in particular, cannot be moved non-destructively relative to the piston rod. In particular, the stationary element is firmly connected to the tube part of the damping valve device. The fastening element is preferably of cylindrical design, for example as a pin or a bolt. For example, the fastening element is pressed into the bore of the stationary element. The fastening element has, in particular, a central shoulder for centring and/or fastening the preload element on/to the fastening element.

According to a further embodiment, the fastening element is connected to the stationary element in such a way that it can be moved in the axial direction in a non-destructive manner. In particular, the fastening element is fastened to the stationary element in such a way that it can be axially positioned in a non-destructive manner relative to the stationary element, in particular by applying an axial force to the fastening element. Preferably, the axial force for positioning the fastening element is applied to the fastening element by means of a tool that can be operated manually or automatically.

According to a further embodiment, the preload element is formed in such a way and lies against the main piston in such a way that the main valve is open in an operating state of the vibration damper, in which the same pressure prevails in the working chambers. The preload element preferably ensures pre-opening of the main valve, such that it, in particular in the non-energized state of the damping valve device and/or in the non-deflected state of the vibration damper, is at least slightly or completely open.

According to a further embodiment, the damping valve device comprises a comfort valve, wherein the stationary element is part of the comfort valve. The damping valve device preferably comprises a comfort valve which can be flowed through by hydraulic fluid in the compression stage and in the rebound stage. In particular, the comfort valve comprises at least one comfort disc spring assembly which, for example, comprises at least one or a plurality of disc springs that lie on a comfort valve seat. The comfort valve preferably has two disc spring assemblies, wherein one is designed for damping the hydraulic fluid in the case of a movement of the piston rod in the rebound direction, and the other disc spring assembly is designed for damping the hydraulic fluid in the case of a movement of the piston rod in the compression direction. The comfort valve preferably comprises a comfort valve body, in which fluid ducts are formed, which can be closed at least partially or completely in a fluid-tight manner by the comfort disc spring assembly. Preferably, the stationary element comprises the comfort valve body, wherein the bore for receiving the fastening element is formed, in particular, in the comfort valve body. The comfort valve is preferably fluidically connected directly to the piston rod-distal working chamber. The comfort valve preferably forms that end of the working piston which points in the direction of the bottom valve. The comfort valve is preferably hydraulically connected in series with the main valve. For example, the preload element is received in a screw or a rivet of the comfort valve or the main piston. The screw or the rivet are preferably arranged such that they attach valve plate assemblies to the main piston valve body.

According to a further embodiment, the preload element comprises a spiral spring, a cup spring and/or a disc spring.

According to a further embodiment, the preload element comprises a first spring element, a second spring element and a guide element connected to the spring elements. The spring elements are, for example, a spiral spring, a cup spring or a disc spring. The preload element is formed, in particular, in multiple parts and comprises, for example, a first spring element, which lies against the main piston, a second spring element, which, in particular, lies against the fastening element, and a guide element, which is preferably directly connected to the first spring element and the second spring element. The guide element is preferably of cylindrical design, in particular formed as a pin or bolt, and at least partially attached in the bore of the stationary element. Preferably, the guide element is not fastened to the stationary element and is preferably attached in a slidable manner relative to the stationary element. The guide element has a central shoulder on the surface pointing in the direction of the main piston for positioning the first spring element. The spring elements preferably lie against the guide element on opposite sides of the latter.

According to a further embodiment, the fastening element is of solid-cylindrical or hollow-cylindrical, tubular or annular design. For example, the stationary element is the guide element, in which the main valve seat is formed. The annular fastening element is preferably pressed to the guide element in such a way that the fastening element can be moved non-destructively, in particular can be positioned, in the axial direction relative to the guide element. The preload element is designed, in particular, as a cup spring and lies against the annular fastening element and the main piston.

According to a further embodiment, the stationary element has a central bore, wherein the fastening element is attached within the bore. The central bore is preferably arranged coaxially to the preload element. In particular, the fastening element forms a press fit with the inner wall of the central bore.

According to a further embodiment, the main piston separates the compression main control chamber, the rebound main control chamber and a pilot control chamber from each other, wherein the damping valve device comprises a pilot valve which is designed in such a way that it can be flowed through by hydraulic fluid in the rebound stage and in the compression stage, with a pilot working chamber and a sliding tappet which is arranged in the pilot working chamber and can be moved axially by means of the armature, and wherein the damping valve device has a connecting duct which is arranged between the pilot control chamber and the pilot work chamber and connects these fluidically to each other.

In particular, the main piston has a closing surface which is adjacent to the pilot control chamber and is arranged in such a manner that the hydraulic pressure prevailing in the pilot control chamber loads the closing surface of the main piston with an axial force acting in the closing direction of the main valve, and wherein the closing surface is formed as a shoulder in the main piston. The main piston is preferably of stepped design and, in particular, has a first piston region which points in the direction of the piston rod-distal working region and, by way of its external diameter, preferably lies in a fluid-tight manner against a positionally fixed housing part of the damping valve device. The first piston region is preferably designed to be substantially cylindrical. The first piston region is adjoined, in particular, by a second cylindrical piston region which is arranged coaxially with the first piston region and preferably has a smaller diameter than the first piston region. An annular, preferably circular disc-shaped, end surface which points in the direction of the drive region is preferably formed on the first piston region. The end surface is preferably designed as a closing surface, in particular as a first closing surface, of the main piston, and, in particular, adjoins the pilot control chamber, such that the hydraulic pressure prevailing in the pilot control chamber loads the main piston, in particular the closing surface of the main piston, with an axial force acting in the closing direction of the main valve.

An annular end surface which points in the direction of the drive region is preferably formed on the second piston region and is formed, in particular, as a second closing surface of the main piston, in addition to the closing surface described above. The second closing surface adjoins the pilot working chamber, such that the hydraulic pressure prevailing in the pilot working chamber loads the second closing surface of the main piston with an axial force acting in the closing direction of the main valve. The entire closing surface of the main piston therefore preferably comprises the first and the second closing surface. In particular, the size and/or the position of the closing surface of the main piston are/is the same for a rebound or compression load of the vibration damper. The sliding tappet is preferably arranged and designed in such a manner that hydraulic fluid can flow through the connecting duct exclusively in one flow direction.

The invention also comprises a method for positioning a preload element of a vibration damper as described above, wherein the method comprises the steps:
setting the preload element onto the main piston,
pre-positioning a fastening element on a stationary element,
loading the damping valve device of the vibration damper with a hydraulic fluid flow,
continuously determining the hydraulic pressure in the first and second working chambers and continuously determining herefrom the pressure difference of the working chambers,
comparing the determined pressure difference with a setpoint value,
moving the fastening element in the axial direction if the determined pressure difference value differs from the setpoint value.

Preferably, the setpoint value is defined manually or automatically depending on the desired damping parameters. The pre-positioning of the fastening element in the stationary element preferably comprises forming a press joint between the fastening element and the stationary element. Preferably, the press joint is formed in such a way that it can be detached by means of a tool in such a way that the fastening element can be moved in the axial direction, in particular can be positioned relative to the stationary element. Preferably, the fastening element is moved in the axial direction exclusively when the determined pressure difference deviates from the setpoint value. When the setpoint value is reached, in particular when the determined pressure difference corresponds with the setpoint value, the fastening element is not moved, preferably by means of the tool, relative to the stationary element.

Preferably, the fastening element is moved in the axial direction to the main piston when the pressure difference exceeds the setpoint value and, in particular, is moved in the axial direction away from the main piston when the pressure difference falls below the setpoint value.

According to a further embodiment, the movement of the fastening element takes place by means of a manually or automatically operable tool.

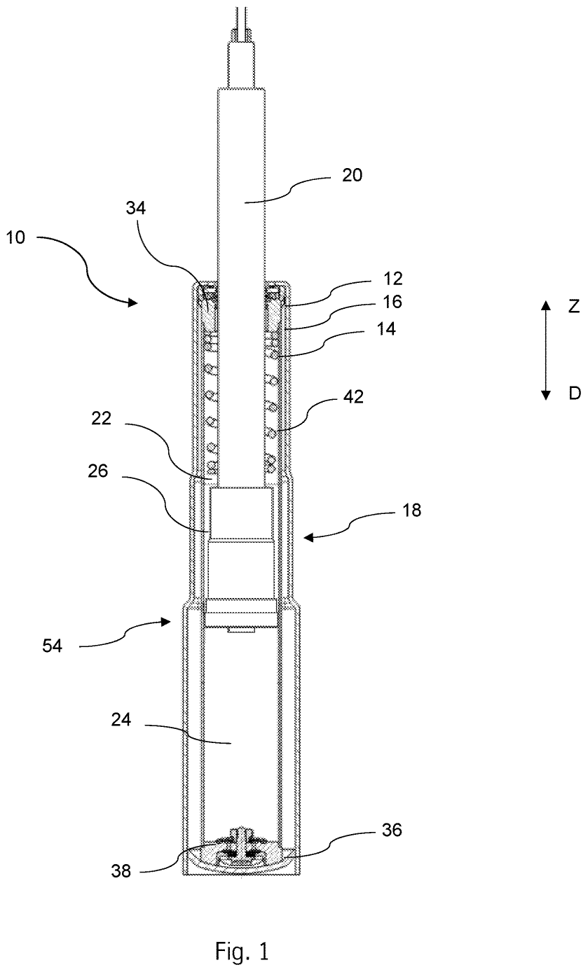

FIG. 1 shows a vibration damper 10, wherein the vibration damper 10 is a multi-tube vibration damper, by way of example a twin-tube vibration damper. The vibration damper 10 has an outer tube 12 which forms an outer surface, in particular a housing, of the vibration damper 10. An inner tube 14, which can also be referred to as a damper tube, is arranged within the outer tube 12 so as to be coaxial with the latter. Formed between the outer tube 12 and the inner tube 14 is an equalizing chamber 16 which is preferably at least partially filled with a hydraulic fluid. For example, the equalizing chamber 16 is partially filled with a gas.

A working piston 18, which is connected to a piston rod 20, is arranged within the inner tube 14 in such a manner that said working piston is movable within the inner tube 14, wherein the inner tube is preferably designed as a guide of the working piston 18. The working piston 18 has a damping valve device 54. The working piston 18 divides the interior of the inner tube 14 into a first working chamber 22, which is arranged on the piston rod side, and a second working chamber 24, which is arranged away from the piston rod.

The interior of the outer tube 12 is fluidically sealed on the piston rod side by means of a closure package 34. Lying opposite the closure package 34, at the piston rod-distal end, the interior of the outer tube 12 is fluidically sealed by means of a bottom piece 36. By way of example, a bottom valve 38, which is attached in particular at the piston rod-distal end of the inner tube 14, is arranged on the bottom piece 36. The bottom valve 38 is, for example, a check valve which is able to be passed through by a flow in both directions or only one direction. The second working chamber 24 is preferably fluidically connected to the equalizing chamber 16 via the bottom valve 38. The piston rod-proximal end of the inner tube 14 and of the outer tube 12 is preferably fastened to the closure package 34.

By way of example, the piston rod 20 has an optional rebound stop which is loaded with a spring force via a spring element 42 in the case of a movement in the rebound direction Z.

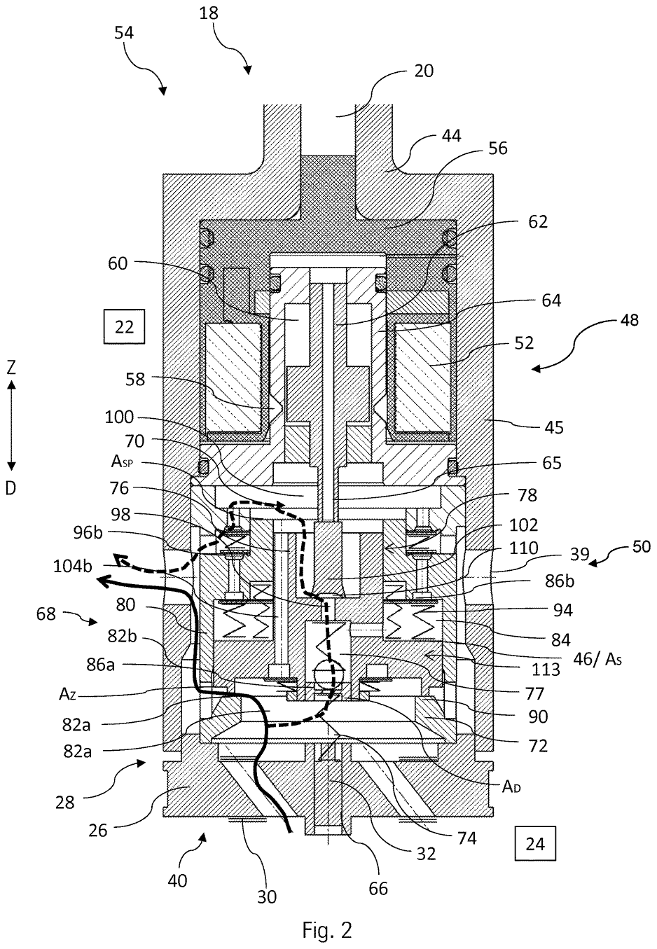

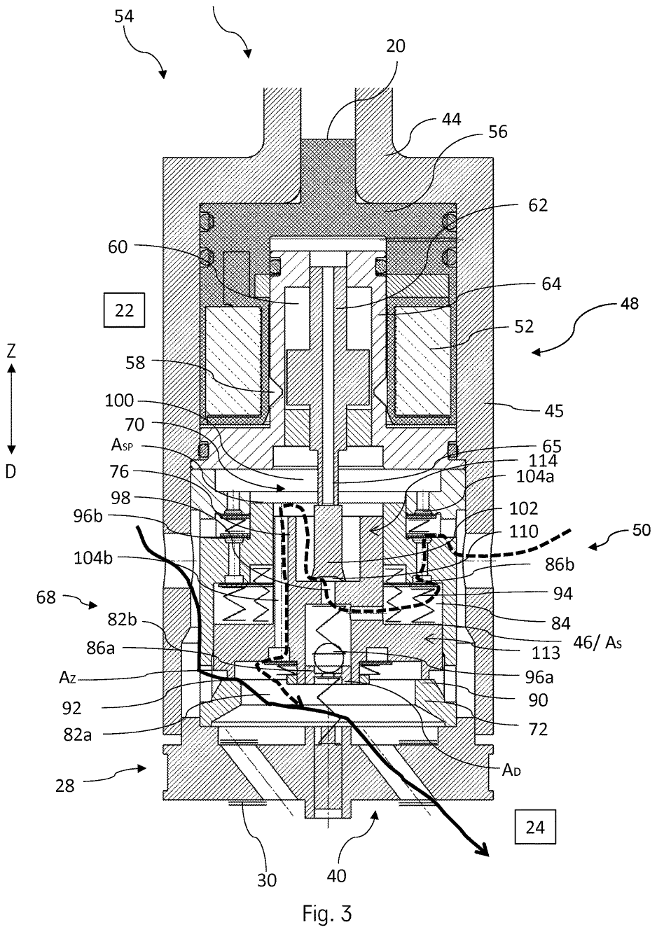

FIG. 2 and FIG. 3 each show an exemplary damping valve device 54 which is preferably arranged in the working piston 18 of the vibration damper 10. FIG. 2 shows the fluid flow in the compression stage, and FIG. 3 shows the fluid flow in the rebound stage, using arrows. The damping valve device 54 is designed, by way of example, as a pilot-controlled pressure control valve and comprises a preferably cylindrical damping valve housing which has, by way of example, a substantially tubular tube part 45 and has a housing upper part 44, the latter being designed in one piece with the tube part 45, for example. The piston rod 20 is preferably attached to the housing upper part 44. The housing upper part 44 has, for example, a connection region (not illustrated) which has one or a plurality of connection contacts for an electrical power supply of the damping valve device 54. The connection contacts for an electrical current supply are preferably connected to a drive unit.

By way of example, the damping valve device 54 has a drive region 48 and a valve region 50. By way of example, the drive region 48 is arranged in the upper region of the damping valve device 54 that faces the piston rod 20, and preferably substantially above the valve region 50, in particular in the rebound direction Z. The drive region 48 preferably comprises a drive in the form of a solenoid. The solenoid comprises a coil 52 having a plurality of windings made of a current-conducting wire. The coil 52 is preferably arranged within the tube part 45 and so as to be concentric with the latter. By way of example, the coil 52 lies against the inner wall of the tube part 45. By way of example, a cover portion 56 is arranged axially between the coil 52 and the housing upper part 44. The coil 52 preferably lies against the cover portion 56 and is, in particular, fastened thereto. The cover portion 56 is formed, for example, from a metal, in particular a magnetic material, preferably a material having a low magnetic resistance. The coil 52 comprises, for example, a coil former, on which the windings of the coil are wound. The coil 52 encloses at least partially or completely an armature chamber 60 which extends centrally in the axial direction. An armature 62 is mounted so as to be axially movable within the armature chamber 60. The armature 62 is preferably of cylindrical design and has a diameter which is slightly smaller than the diameter of the armature chamber 60, such that the armature 62 is preferably attached so as to be able to slide in the axial direction. By way of example, the armature 62 comprises a central armature rod 65 which, by way of example, has a round cross section and extends centrally in the axial direction through the armature chamber 60. The armature chamber 60 is preferably delimited by an at least partially hollow-cylindrical pole tube 64. The pole tube 64 preferably has a bottom and is designed to be open, in particular, in the direction of the valve region 50. The pole tube 64 is preferably made of a magnetizable or magnetic material and has, for example, a magnetic separation 58.

The coil 52 is preferably designed and arranged in such a manner that, when loaded with current, it forms a magnetic field which has magnetic field lines which preferably run substantially in the axial direction in the armature chamber 60. The armature 62 is preferably made of a magnetizable or magnetic material and is movable in the axial direction, corresponding to the magnetic field formed by means of the coil 52.

The hollow-cylindrical region of the pole tube 64 is adjoined in the axial direction and coaxially therewith by a pole tube element, conjointly forming the pole tube 64, wherein the pole tube 64 is formed in particular in multiple parts, integrally or in one part. The pole tube 64 has an upper tubular region with an, in particular, constant internal diameter, which is preferably formed as a hollow cylinder and extends, by way of example, from the cover portion 56 in the axial direction as far as beyond the armature 62. The upper hollow-cylindrical region is adjoined in the axial direction by a lower region with an enlarged diameter, wherein the external surface of the pole tube 64 preferably extends as far as the tube part 45 and at least partially lies against the latter and is sealed in a fluid-tight manner in relation to the tube part 45 by means of, for example, a sealing element. The tube part 45 encloses at least partially or completely a valve region 50 in the axial and in the circumferential direction, said valve region being explained in more detail in one of the following paragraphs.

By way of example, the valve region 50 comprises a main valve 68 and a pilot valve 70. Preferably, the damping valve device 54 arranged in the working piston 18 has exactly one main valve 68 and/or exactly one pilot valve 70. Preferably, the main valve 68 and/or the pilot valve 70 are/is able to be flowed through by hydraulic fluid in the case of a movement of the piston rod 20 in the rebound direction Z and in the compression direction D. Attached to the working piston 18 is preferably a seal, for example a sealing ring, which seals the working piston 18 in a fluid-tight manner in relation to the damper tube 14. Furthermore, the damping valve device 54 optionally has a comfort valve 28. The comfort valve 28 is preferably designed in such a way that it is able to be flowed through by hydraulic fluid both in the compression direction D and in the rebound direction Z. In particular, the comfort valve comprises at least one comfort disc spring assembly which, for example, comprises at least one or a plurality of disc springs that lie on a comfort valve seat. The comfort valve 28 preferably has two disc spring assemblies, wherein one is designed for damping the hydraulic fluid in the case of a movement of the piston rod 20 in the rebound direction Z and the other disc spring assembly is designed for damping the hydraulic fluid in the case of a movement of the piston rod 20 in the compression direction D. The comfort valve 28 preferably comprises a comfort valve body 26, in which fluid ducts are formed, which can be closed by the comfort spring disc assembly at least partially or completely in a fluid-tight manner. The comfort valve 28 is preferably fluidically connected directly to the piston rod-distal working chamber 24. Preferably, the comfort valve 28 is arranged in the piston rod-distal working chamber 24 and, in particular, forms the end of the working piston 18 that points in the direction of the bottom valve 36.

The working piston 18 comprises a first fluid passage 39 to the first working chamber 22, wherein the first fluid passage 39 is formed by way of example in the tube part 45, by way of example as a circular opening. The damping valve device 54 is preferably fluidically connected to the first, piston rod-proximal working chamber 22 via the first fluid passage 39. By way of example, in the case of a movement of the piston rod 20 in the rebound direction Z, the first fluid passage 39 is formed as a fluid inlet for admitting hydraulic fluid into the damping valve device 54 and, in the case of a movement of the piston rod in the compression direction D, is formed as a fluid outlet for discharging hydraulic fluid from the damping valve device 54.

The working piston 18, in particular the comfort valve 28, preferably has a second fluid passage 40 to the second working chamber 24, via which the damping valve device 54 is preferably fluidically connected to the second, piston rod-distal working chamber 24. By way of example, the second fluid passage 40, in the case of a movement of the piston rod 20 in the compression direction D, is formed as a fluid inlet for admitting hydraulic fluid into the comfort valve 28 and the main valve 68, and in the case of a movement of the piston rod in the rebound direction Z, is formed as a fluid outlet for discharging hydraulic fluid from the comfort valve 28 and the main valve 68.

During operation of the damping valve device 54, in the case of a piston rod movement in the rebound direction Z, the hydraulic fluid preferably flows from the first fluid passage 39 into the main valve 68, and into the pilot valve 70, and subsequently optionally through the comfort valve 28 and to the second fluid passage 40. The main valve 68 comprises a main piston 76 which is arranged so as to be axially movable within a main working chamber 78. By way of example, the main valve 68 also comprises a housing part 80 which at least partially delimits the main working chamber 78 and forms an axial guide for the main piston 76. The housing part 80 is arranged, for example, within the tube part 45 and so as to be coaxial with the latter. A gap, in particular an annular space, is preferably formed between the housing part 80 and the tube part 45. The main piston 76 is preferably arranged within the housing part 80 and so as to be concentric with the latter. The main piston 76 preferably divides the main working chamber 78 into a compression main control chamber 82a, a rebound main control chamber 82b and a pilot control chamber 84. The main piston 76 has, in particular, a first flow passage 86a which extends through the main piston 76 and forms a fluidic connection of the compression main control chamber 82a to the pilot control chamber 84. By way of example, the first flow passage 86a extends centrally and in the axial direction through the main piston 76. By way of example, the housing part 80 has a second flow passage 86b which forms a fluidic connection of the rebound main control chamber 82b to the pilot control chamber 84. By way of example, the second flow passage 86b is arranged at the same height as the first fluid passage 39. The first and the second flow passage 86a,b preferably each have a respective flow throttle 96a,b, in particular a cross-sectional constriction.

The compression main control chamber 82a is formed by way of example between the comfort valve 28 and the main piston 76. The rebound main control chamber 82b is preferably formed as the gap described above, in particular the annular space, between the housing part 80 and the tube part 45. The hydraulic pressure of the second, piston rod-distal working chamber 24 preferably prevails in the compression main control chamber 82a, wherein the pressure of the first, piston rod-proximal working chamber 22 preferably prevails in the rebound main control chamber 82b.

A guide element 72 is preferably arranged in a positionally fixed manner in the damping valve device 54 between the main valve 68 and the comfort valve 28. By way of example, the guide element 72 is of tubular design and serves for directing hydraulic fluid from the comfort valve 28 to the main valve 68. By way of example, the guide element 72 forms at least partially the compression main control chamber 82a. The guide element 72 is preferably connected directly or indirectly to the tube part 45 and is arranged in a positionally fixed manner relative to the latter. A main valve seat 90 is preferably formed on the guide element 72. Attached to the main piston 76 is, for example, a spring assembly (not shown) which, in the closed position of the main valve 68, lies against the main valve seat 90 of the guide element 72.

In the open position of the main valve 68, in which the main piston 76 is moved away from the main valve seat 90 in the axial direction, the main piston 76 is lifted from the main valve seat 90, such that a main flow duct 92 is formed between the main piston 76 and the main valve seat 90. The main flow duct 92 forms a fluidic connection between the first and the second working chamber 22, 24. In particular, the main flow duct 92 forms a fluidic connection between the compression main control chamber 82a and the rebound main control chamber 82b.

The main piston 76 is preferably of stepped design and has, by way of example, a first piston region 113 that points in the direction of the piston rod-distal working chamber 24 and, by way of its outer diameter, lies against the housing part 80 in a fluid-tight manner. By way of example, the first piston region 113 is of substantially cylindrical design. The first piston region 113 is adjoined by a second cylindrical piston region 114 which is arranged so as to be coaxial with the first piston region 113 and has a smaller diameter than the first piston region 113. An annular end surface 46 that points in the direction of the drive region 48 is preferably formed on the main piston 76, in particular on the first piston region 113. The end surface 46 serves as a closing surface A_{S} of the main piston 76 and adjoins the pilot control chamber 84, such that the hydraulic pressure prevailing in the pilot control chamber 84 loads the main piston 76, in particular the closing surface 46 of the main piston 76, with an axial force acting in the closing direction of the main valve. The pilot control chamber 84 is preferably delimited by the closing surface 46, the housing part 80 and the main piston 76, in particular the second region of the main piston 76. The first flow passage 86a for connecting the compression main control chamber 82a preferably extends exclusively through the first region of the main piston 76, in particular centrally and in the axial direction through said main piston into the pilot control chamber 84. The first flow passage 86a preferably has a check valve which is arranged in such a manner that a hydraulic flow is enabled from the compression main control chamber 82a into the pilot control chamber 84 and is prevented in the opposite direction. The second flow passage 86b preferably likewise has a check valve which is arranged in such a manner that a hydraulic flow is enabled from the rebound main control chamber 82b into the pilot control chamber 84 and is prevented in the opposite direction.

An annular end surface A_{SP} that points in the direction of the drive region 48 is preferably formed on the main piston 76, in particular on the second piston region 114. The end surface A_{SP} serves, in addition to the closing surface A_{S}, as a further, in particular second, closing surface A_{SP} of the main piston 76 and adjoins the pilot working chamber 100, such that the hydraulic pressure prevailing in the pilot working chamber 100 loads the main piston 76, in particular the closing surface A_{SP} of the main piston 76, with an axial force acting in the closing direction of the main valve 68.

Attached to that side of the main piston 76 that faces away from the main valve seat 90 is a spring element 94 which is arranged in such a manner that it loads the main piston 76 with a spring force acting in the direction of the valve seat 90. The spring element 94 is, for example, a spiral spring which lies against the internal face of a hollow-cylindrical region of the housing part 80 and, by way of one end, is supported on the end surface 46, in particular the closing surface A_{S}, of the main piston 76, said end surface pointing in the direction of the drive region 48. The spring element 94 is preferably supported by way of the other end on the housing part 80. By way of example, the housing part has a groove, in which the spring element 94 is arranged.

A connecting duct 98 which, in particular, extends centrally and in the axial direction from the pilot control chamber 84 through the main piston 76 into a pilot working chamber 100 is preferably formed in said main piston. Preferably, the connecting duct 98 forms the fluid inlet into the pilot valve 70. That region of the main piston 76 that points in the direction of the drive region 48 is, by way of example, designed to be hollow-cylindrical, wherein the interior of the hollow-cylindrical region preferably forms at least partially the pilot working chamber 100. Preferably, the pilot working chamber 100 fluidically adjoins directly the connecting duct 98.

By way of example, the pilot valve 70 comprises a sliding tappet 102 which is arranged so as to be axially movable within the pilot working chamber 100. The sliding tappet 102 preferably lies by way of its end that faces away from the main valve 68 against the armature 62, in particular the armature rod 65, such that the movement of the armature 62 and of the sliding tappet 102 is coupled at least in the case of the movement of the armature 62 in the direction of the sliding tappet 102. In a closed position of the pilot valve 70, the sliding tappet 102 preferably lies against the main piston 76 in such a way that the connecting duct 98 is completely closed by the sliding tappet 102. In an open position of the pilot valve 70, the sliding tappet 102 is lifted from the main piston 76, such that the connecting duct 98 is opened by the sliding tappet 102 and a fluid flow takes place between the pilot control chamber 84 of the main valve 68 and the pilot working chamber 100. The sliding tappet 102 is preferably attached so as to be axially movable relative to the main piston 76. In particular, the sliding tappet 102 is guided axially by the main piston 76 and preferably lies, in particular in a fluid-tight manner, against the inner wall of the hollow-cylindrical region of the main piston 76.

By way of example, the sliding tappet 102 has a T-shaped longitudinal section, wherein the sliding tappet 102 has a first region that faces the connecting duct 98 and has a cross section which is greater than the cross section of the connecting duct 98, and a second region that faces the armature 62 and has a greater cross section than the first region. The second region preferably extends over the entire cross section of the pilot working chamber 100.

In the closed position, the sliding tappet 102 preferably lies against a first valve seat which is formed in the main piston 76.

The sliding tappet 102 preferably has an opening surface 110 which is formed on the first region of the sliding tappet that faces the connecting duct 98, and is arranged in such a manner that it closes the connecting duct 98 in the closed position of the pilot valve 70. The opening surface 110 is likewise referred to as pilot opening surface A_{P}, for example, and preferably has an, in particular central, recess that points in the axial direction and is of conical design, by way of example. The recess can be designed, for example, so as to be cylindrical, having a round, circular or angular cross section. The recess preferably serves to enlarge the opening surface and thus to set the opening pressure of the pilot valve 70.

The pilot valve 70 preferably comprises a first pilot outflow duct 104a which is designed and arranged for fluidically connecting the pilot working chamber 100 to the first fluid passage 39, preferably to the piston rod-proximal working chamber 22. The first pilot outflow duct 104a is formed by way of example in the housing part 80, in particular in a housing element fixedly connected thereto, and preferably extends from the pilot working chamber 100 into the rebound main control chamber 82b. The first pilot outflow duct 104a preferably has a check valve which is arranged in such a manner that a hydraulic flow is enabled from the pilot working chamber 100 into the first fluid passage 39 and is prevented in the opposite direction.

The pilot valve 70 preferably comprises a second pilot outflow duct 104b which is designed and arranged for fluidically connecting the pilot working chamber 100 to the second fluid passage 40, preferably to the piston rod-distal working chamber 24. The second pilot outflow duct 104b is formed by way of example in the main piston 76 and preferably extends axially through the latter, in particular through the first and the second piston region. The second pilot outflow duct 104b preferably extends from the pilot working chamber 100 into the compression main control chamber 82a. The second pilot outflow duct 104b preferably has a check valve which is arranged in such a manner that a hydraulic flow is enabled from the pilot working chamber 100 into the second fluid passage 40 and is prevented in the opposite direction.

During operation of the damping valve device 54, in the case of a movement of the piston rod 20 in the compression direction D, the hydraulic fluid flows through the second fluid passage 40 into the optional comfort valve 28, into the compression main control chamber 82a, wherein the main piston 76 is loaded with an opening force by the pressure in the compression main control chamber 82a and is moved axially upwards. Here, the main piston 76 is lifted from the main valve seat 90 and the hydraulic fluid flows through the main flow duct 92 to the rebound main control chamber 82b, in particular the second fluid passage 39. At the same time, a sub-flow of the hydraulic fluid flows through the first flow passage 86a in the main piston 76 to the pilot control chamber 84 and loads the main piston 76 with a closing force acting in the direction of the main valve seat 90. The closing force determines the opening width of the main valve 68, in particular the cross section of the main flow duct 92, which determines the damping force of the damping valve device 54. The pressure in the pilot control chamber 84 is set by the pilot valve 70, wherein the hydraulic fluid flows from the pilot control chamber 84 through the connecting duct 98 into the pilot working chamber 100 which is released by the sliding tappet 102. The opening width of the connecting duct 98 is dependent on the axial position of the sliding tappet 102, which is set, in particular predefined, by means of a solenoid 54. In the closed position of the pilot valve 70, the sliding tappet 102 preferably closes the connecting duct 98 completely, such that the hydraulic pressure in the pilot control chamber 84 increases to a maximum value and the main valve 68 is closed and preferably loaded with a force acting in the closing direction, by the main piston 76 being pressed onto the main valve seat 90. In an open position of the pilot valve 70, the connecting duct 98 is at least partially released by the sliding tappet 102, such that a hydraulic flow flows into the pilot working chamber 100, and via a first pilot outflow duct 104a to the rebound main control chamber 82b, in particular the second fluid passage 39. The fluid flow in the case of a movement of the piston rod 20 in the compression direction D is schematically illustrated by the arrows in FIG. 2, wherein the solid line represents the main flow through the main valve 68 and the dashed line represents the pilot flow through the pilot valve 70.

FIG. 3 shows the damping valve device 54 of FIG. 2, wherein the fluid flow in the case of a movement of the piston rod in the rebound direction is illustrated. The main piston 76 preferably has a rebound opening surface A_{Z} and a compression opening surface A_{D}. The compression opening surface A_{D} is the surface of the main piston 76 directly adjacent to the compression main control chamber 82a, wherein the rebound opening surface A_{Z} is the surface of the main piston 76 directly adjacent to the rebound main control chamber 82b.

A preload element 74 lies against the main piston 76, for example, in such a way that it applies a preload force to the main piston 76 in the opening direction of the main valve 68. The preload element 74 is preferably a spiral spring or a cup spring or a disc spring. As an example, the preload element 74 lies against the surface of the main piston 76 facing in the direction of the second working chamber 24, in particular facing in the direction of the comfort valve 28. Preferably, the preload element 74 is arranged in a central recess 77, in particular bore, of the main piston 76. The central recess 77 is preferably arranged coaxially to the connecting duct 98, preferably merges into the connecting duct 98 or forms this at least partially. The recess 77 preferably extends centrally along the central axis of the vibration damper 10.

The main valve 68 is preferably in an open position in an operating state of the vibration damper 10, in which the same pressure prevails in both working chambers 22, 24.

The preload element 74 is preferably attached with one end to the main piston 76 and with the other end to a stationary element of the vibration damper 10, in particular the damping valve device 54. Preferably, the preload element 74 is fastened to the stationary element by means of a fastening element 32. The stationary element is preferably attached in a stationary manner within the working piston 18 and, in particular, cannot be moved non-destructively relative to the piston rod 20. In particular, the stationary element is firmly connected to the tube part 45 of the damping valve device 54. The stationary element is preferably part of the comfort valve 28, in particular the comfort valve body 26. By way of example, the comfort valve body 26 has a central bore 66 which extends axially completely through the valve body.

The fastening element 32 is by way of example a cylindrical pin or a bolt. The fastening element 32 is preferably connected to the stationary element in a positively and/or non-positive locking manner. For example, the fastening element 32 is pressed to the stationary element, in particular pressed into the bore 66 of the stationary element. The fastening element 32 has, in particular, a central shoulder for centring and/or fastening the preload element 74 to the fastening element 32. Preferably, the fastening element 32 is fastened within the stationary element in such a way that it can be moved in the axial direction in a non-destructive manner.

The stationary element is by way example the comfort valve body 26 in the exemplary embodiment of FIGS. 2 and 3.

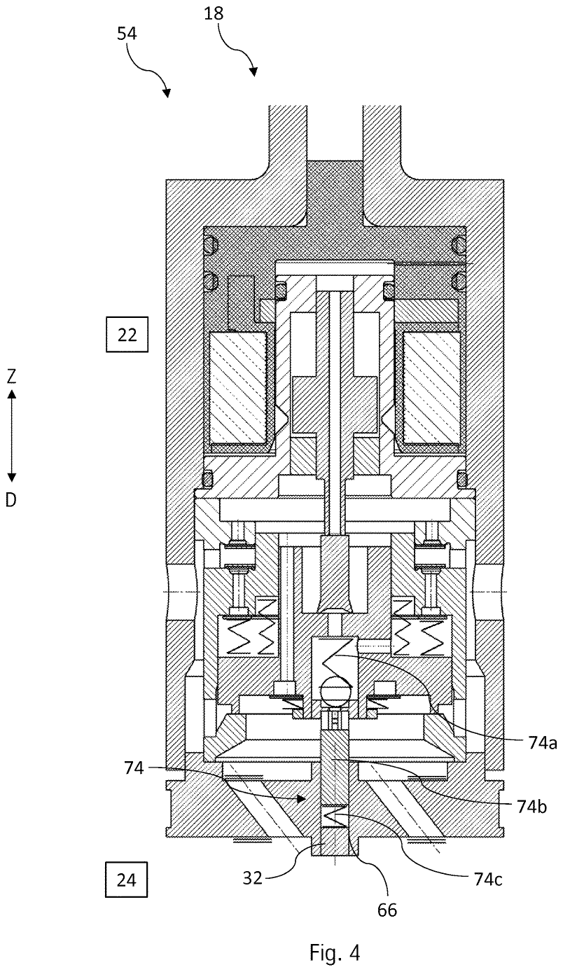

FIG. 4 shows a further exemplary embodiment of a damping valve device 54, which mostly corresponds to the damping valve device in FIGS. 2 and 3. In contrast to the damping valve device 54 of FIGS. 2 and 3, the damping valve device 54 of FIG. 4 has a preload element 74 which is formed in multiple parts. The preload element 74 comprises, by way of example, a first spring element 74a which lies against the main piston 76, a second spring element 74c which lies against the fastening element 32, and a guide element 74b which is directly connected to the first spring element 74a and the second spring element 74c. The guide element 74b is preferably of cylindrical design, in particular formed as a pin or bolt, and is at least partially attached in the bore 66 of the stationary element. Preferably, the guide element 74b is not fastened to the stationary element and is preferably attached in a slidable manner relative to the stationary element. The guide element 74b has a central shoulder for positioning the first spring element 74 a on the surface pointing in the direction of the main piston 76. The spring elements 74a, c preferably lie against the guide element 74b on opposite sides thereof. The preload element 74 preferably counteracts the spring element 94, wherein preferably the spring element 94 and the preload element 74 are in equilibrium in the case of a defined pre-opening of the piston.

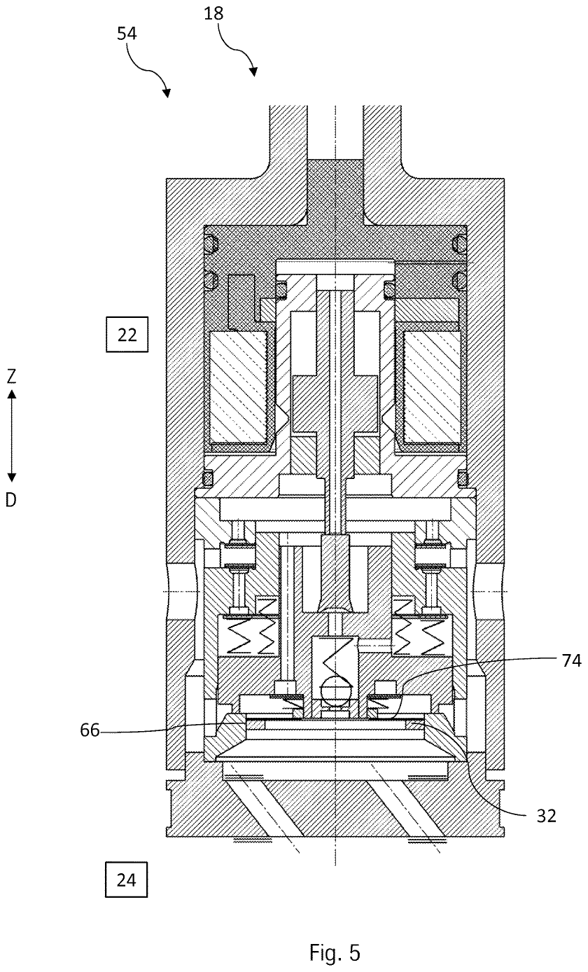

FIG. 5 shows a further exemplary embodiment of a damping valve device 54, which mostly corresponds to the damping valve device of FIGS. 2, 3 and 4. In contrast to the damping valve device 54 of FIGS. 2, 3 and 4, the damping valve device 54 of FIG. 5 has an annular fastening element 32. The stationary element is the guide element 72, in which the main valve seat 90 is formed. The annular fastening element 32 is preferably pressed to the guide element 72 in such a way that the fastening element 32 can be moved, in particular can be positioned, in the axial direction relative to the guide element 72 in a non-destructive manner. The preload element 74 is formed by way of example in the exemplary embodiment of FIG. 5 as a cup spring and lies against the annular fastening element 32 and the main piston 76.

The positioning of the preload element 74 in the vibration damper 10, in particular the damping valve device 54, preferably comprises the following steps:
setting the preload element 74 onto the main piston
pre-positioning a fastening element 32 on a stationary element
loading the damping valve device 54 of the vibration damper 10 with a hydraulic fluid flow
continuously determining the hydraulic pressure in the first and second working chamber 22, 24 and, from this, determining the pressure difference of the working chambers 22, 24
defining a setpoint value for the pressure difference and comparing the pressure difference with the setpoint value
moving the fastening element 32 in the axial direction, in particular by means of a tool that can be operated manually or automatically, if the determined value of the pressure difference differs from the setpoint value.

The pre-positioning of the fastening element in the stationary element preferably comprises forming a press joint between the fastening element and the stationary element. Preferably, the press joint is formed in such a way that it can be detached by means of a tool in such a way that the fastening element can be moved in the axial direction, in particular can be positioned relative to the stationary element. Preferably, the fastening element is moved in the axial direction exclusively when the determined pressure difference deviates from the setpoint value. When the setpoint value is reached, in particular when the determined pressure difference corresponds with the setpoint value, the fastening element is not moved, preferably by means of the tool, relative to the stationary element.

### LIST OF REFERENCE SIGNS

10 Vibration damper
12 Outer tube
14 Inner tube
16 Equalizing chamber
18 Working piston
20 Piston rod
22 First/piston rod-proximal working chamber
24 Second/piston rod-distal working chamber
26 Comfort valve body
28 Comfort valve
30 Comfort disc spring assembly
32 Fastening element
34 Closure package
36 Bottom piece
38 Bottom valve
39 First fluid passage to the first working chamber 22
40 Second fluid passage to the second working chamber 24
42 Spring element
44 Housing upper part
45 Tube part
46 End surface/closing surface
48 Drive region
50 Valve region
52 Coil
54 Damping valve device
56 Cover portion
58 Magnetic separation
60 Armature chamber
62 Armature
64 Pole tube
65 Armature rod
66 Bore
68 Main valve
70 Pilot valve
72 Guide element
74 Preload element
76 Main piston
77 Central recess
78 Main working chamber
80 Housing part
82a,b Rebound/compression main control chamber
84 Pilot control chamber
86a,b Flow passage
90 Main valve seat
92 Main flow duct
94 Spring element
96a,b Flow throttle
98 Connecting duct
100 Pilot working chamber
102 Sliding tappet
104a First pilot outflow duct
104b Second pilot outflow duct
110 Opening surface of the sliding tappet
113 First piston region
114 Second piston region
A_{S} First closing surface of the main piston 76
A_{D} Compression opening surface of the main piston 76
A_{Z} Rebound opening surface of the main piston 76
A_{SP} Second closing surface of the main piston 76

1. A vibration damper of a motor vehicle, comprising:
an outer tube and an inner tube which is arranged so as to be coaxial with the outer tube;
a working piston which is arranged so as to be axially movable within the inner tube and separates the interior of the inner tube into a first, piston rod-proximal working chamber and a second, piston rod-distal working chamber; and
a damping valve device, including:
a coil;
an axially movable armature which is at least partially arranged within the coil; and
a main valve having a main piston which separates a compression main control chamber and a rebound main control chamber from one another;
wherein a preload element is provided which lies against the main piston in such a way that it applies a force to the main piston in the opening direction of the main valve.

2. The vibration damper according to claim 1, wherein the preload element is attached by a fastening element to at least one stationary element of the damping valve device.

3. The vibration damper according to claim 2, wherein the fastening element is connected to the stationary element in a non-positively and/or positively locking manner.

4. The vibration damper according to claim 2, wherein the fastening element is pressed to the stationary element in a non-positively and/or positively locking manner.

5. The vibration damper according to claim 2, wherein the fastening element is connected to the stationary element in such a way that it can be moved in the axial direction in a non-destructive manner.

6. The vibration damper according to claim 1, wherein the preload element is formed and lies against the main piston in such a way that the main valve is open in an operating state of the vibration damper, in which the same pressure prevails in the working chambers.

7. The vibration damper according to claim 2, wherein the damping valve device comprises a comfort valve, and wherein the stationary element is part of the comfort valve.

8. The vibration damper according to claim 1, wherein the preload element comprises a spiral spring, a cup spring or a disc spring.

9. The vibration damper according to claim 1, wherein the preload element has a first spring element, a second spring element and a guide element connected to the spring elements.

10. The vibration damper according to claim 2, wherein the fastening element is of cylindrical or annular design.

11. The vibration damper according to claim 10, wherein the stationary element has a central bore, and wherein the fastening element is attached within the bore.

12. The vibration damper according to claim 1, wherein the main piston separates the compression main control chamber, the rebound main control chamber and a pilot control chamber from each other, and wherein the damping valve device has a pilot valve which is designed in such a way that it can be flowed through by hydraulic fluid in the rebound stage and in the compression stage, with a pilot working chamber and a sliding tappet which is arranged in the pilot working chamber and can be moved axially by the armature, and wherein the damping valve device has a connecting duct which is arranged between the pilot control chamber and the pilot working chamber and connects them to each other fluidically.

13. A method for positioning a preload element of a vibration damper according to claim 1,
wherein the method comprises:
setting the preload element onto the main piston;
pre-positioning a fastening element on a stationary element;
loading the damping valve device of the vibration damper with a hydraulic fluid flow;
continuously determining the hydraulic pressure in the first and second working chambers and, from this, continuously determining the pressure difference of the working chambers;
comparing the determined pressure difference with a setpoint value; and
moving the fastening element in the axial direction if the determined value of the pressure difference differs from the setpoint value.

14. The method according to claim 13, wherein the movement of the fastening element is carried out by a manually or automatically operable tool.
